(19) United States
(12) Patent Application Publication
(10) Pub. No.: US 2016/0101656 A1
(43) Pub. Date: Apr. 14, 2016

(54) PREPARATON OF APEX/BEAD COMPOSITE AND TIRE WITH PRE-APEXED BEAD

(71) Applicant: The Goodyear Tire & Rubber Company, Akron, OH (US)

(72) Inventors: Paul Harry Sandstrom, Cuyahoga Falls, OH (US); James Joseph Golden, North Canton, OH (US); Joseph Henry Laco, Akron, OH (US)

(21) Appl. No.: 14/513,471

(22) Filed: Oct. 14, 2014

(51) Int. Cl. B60C 15/06; B29D 30/06; C08L 9/00; B29D 30/08

(52) U.S. Cl. CPC B60C 15/0603; B29D 30/08; B29D 30/0681; C08L 9/00; B60C 2001/0058

(57) ABSTRACT

The invention relates to preparation of an apex/bead composite as a pre-apexed bead, and pneumatic tire containing such pre-apexed bead. The invention relates to such pre-apexed bead where the apex is comprised of a rubber composition which contains a syndiotactic-1,2-polybutadiene polymer.

### FIELD OF THE INVENTION

The invention relates to preparation of an apex/bead composite as a pre-apexed tire bead, and pneumatic tire containing such pre-apexed bead. The invention relates to such pre-apexed bead where the apex is comprised of a rubber composition which contains a syndiotactic-1,2-polybutadiene polymer.

### BACKGROUND OF THE INVENTION

Pneumatic tires are usually comprised of a circumferential tread and spaced apart beads with a sidewall extending from the beads to the tread and a carcass supporting the tread and sidewall components. The tire sidewalls usually contain a rubber apex within the sidewall which extends from a tire bead radially outward into the tire sidewall to add stiffness to the tire sidewall to thereby promote beneficial handling characteristics to the tire.

In practice, the pneumatic tire is usually built as an assembly of components which includes individually assembling the apex and bead components together with other components to form a tire assembly which is then cured in a suitable mold to form the tire.

For this invention, it is desired to pre-form a composite of uncured apex rubber strip applied circumferentially around an annular bead of rubber encapsulated plurality of metal, or wire, cords to thereby form a pre-apexed bead. A tire is prepared by building an assembly of components including such pre-apexed bead and then curing the assembly to form the tire.

The envisioned methodology of providing a pre-apexed tire bead by pre-forming the composite of circumferential apex strip around an annular bead is comprised of extruding a shaped uncured rubber apex strip onto and circumferentially around an annular bead of uncured rubber encapsulated plurality of metal cords is considered to be a departure from past practice.

For such envisioned methodology of applying an uncured apex rubber strip onto and around the circumference of an annular bead, it is readily seen that the peripheral outer portion of the uncured rubber apex strip necessarily stretches to extend, or travel, a greater distance than the peripheral inner portion of the rubber apex strip around the annular bead. As the peripheral outer portion of the extruded uncured rubber apex is stretched to a greater length than its peripheral inner portion it has been observed that, because the stretched apex strip is elastomeric in nature, it has a natural tendency to try to shrink and thereby return to its original unstretched shape. As a result, the stretched elastomeric peripheral outer portion of the uncured apex strip tends to undesirably shrink and thereby deform and curl inward toward its peripheral inner portion.

Therefore a challenge is presented to enable such preparation of pre-formed apex/bead combination (pre-apexed bead) for which the outer portion of the apex uncured rubber strip can substantially maintain its stretched shape upon being applied onto and circumferentially around the annular tire bead component.

For such challenge, it is therefore proposed to evaluate reducing the elastomeric characteristic of the apex rubber strip by adding a thermoplastic syndiotactic-1,2-polybutadiene polymer in its rubber composition to thereby make the uncured rubber composition somewhat less elastomeric in nature to thereby allow the rubber composition, when stretched, to significantly reduce or substantially eliminate the aforesaid shrinking and curling of the outer peripheral portion of the uncured apex rubber strip.

The thermoplastic syndiotactic-1,2-polybutadiene polymer is chosen because it can be sulfur cured together with other diene-based elastomers present in the cured rubber composition with suitable elastomeric properties for the tire apex component of the tire.

Syndiotactic-1,2-polybutadiene polymer is recognized as being a crystalline thermoplastic polymer and therefore in its uncured state rather than being elastomeric. However, upon blending with various diene-based elastomers to form a rubber composition, it exhibits elastomeric rubbery properties when the rubber composition is sulfur cured.

Historically, syndiotactic polybutadiene has been proposed for use in various rubber compositions for various tire components for various purposes such as, for example, tire carcass, innerliner and apex components. For example, see U.S. Pat. Nos. 5,307,850, 6,156,143, 6,202,726, 6,539,996, 6,956,093 and 8,536,262.

As indicated, because the uncured apex rubber strip contains the thermoplastic syndiotactic polybutadiene, it is somewhat less elastomeric in nature.

Being less elastomeric, it is envisioned that the uncured rubber apex, particularly its outer peripheral portion, may have a reduced tendency to attempt to return to its original shape after circumferentially stretching it when being wrapped circumferentially around the annular bead and thereby less tendency to curl inward to present the aforesaid unwanted altered apex shape and to thereby beneficially enable inserting the apex/bead composite into the tire assembly for preparation of a pneumatic tire.

Therefore, it is proposed to evaluate a process of preparation of an uncured apex/bead composite for preparation of a pneumatic tire where the apex is comprised of an uncured rubber composition which contains a syndiotactic-1,2-polybutadiene thermoplastic polymer having a melting point in a range of from about 70° C. to about 130° C. and below a maximum mixing temperature reached (e.g. about 140° C. to about 170° C.) for mixing the rubber composition containing the syndiotactic-1,2-polybuadiene so that the thermoplastic syndiotactic-1,2-polybutadiene will readily melt into and disperse within the rubber composition as it is being mixed.

In the description of this invention, the term “phr” where used means “parts of material by weight per 100 parts by weight of rubber”. The terms “rubber” and “elastomer” may be used interchangeably unless otherwise indicated. The terms “rubber composition” and “compound” may be used interchangeably unless otherwise indicated.

A polymer melting point (MP), where referenced, may be determined, for example, as minimum endotherm values from differential scanning calorimetry (DSC) curves as conventionally used and understood by those having skill in such art.

### SUMMARY AND PRACTICE OF THE INVENTION

In accordance with this invention, a method (process) of preparing a tire apex/bead composite as a pre-apexed bead comprises mixing a sulfur curable rubber composition and extruding the mixed uncured sulfur curable rubber composition through a suitable die to form and apply an uncured rubber apex strip onto and circumferentially around the outer peripheral surface of an annular tire bead, where said tire bead is comprised of uncured sulfur curable rubber encapsulated plurality of wire cords (e.g. metal cords such as for example brass coated steel cords),

whereby the radially outer portion (e.g. radially outer peripheral portion) of the uncured rubber apex strip is caused by such method to be stretched beyond its original extruded length (as the apex is applied onto and around the periphery of the annular tire bead) and beyond the length of the radially inner portion of the apex (beyond the length of the radially inner peripheral portion of the uncured rubber apex adjacent to the annular bead which retains its approximate original extruded length),

wherein the composition of the rubber apex is comprised of:

(A) at least one diene-based elastomer comprised of at least one of cis 1,4-polyisoprene, polybutadiene (e.g. high cis 1,4- or high trans 1,4-polybutadiene) and styrene/butadiene rubber (e.g. comprised of cis1,4-polyisoprene rubber and at least one of polybutadiene rubber and styrene/butadiene rubber),

(B) about 1 to about 10, alternately from about 3 to about 7, parts by weight thermoplastic syndiotactic-1,2-polybutadiene per 100 parts by weight of the diene-based elastomer(s), wherein the thermoplastic syndiotactic-1,2-polybutadiene has a melting point (MP) in a range of from about 70° C. to about 130° C. and

(C) about 30 to about 120, alternately about 50 to about 100 phr of reinforcing filler comprised of:
(1) rubber reinforcing carbon black, or
(2) combination of rubber reinforcing carbon black and precipitated silica together with a coupling agent for the precipitated silica having a moiety reactive with hydroxyl groups (e.g. silanol groups) on the precipitated silica and another different moiety interactive with said diene-based elastomer(s).

In one embodiment, the melting point (MP) of the syndiotactic-1,2-polybutadiene is at least 10° C. lower than the maximum temperature reached for the mixing of the rubber composition (e.g. a maximum mixing temperature for the rubber composition in a range of from about 140 to about 180° C., alternately from about 150 to about 170° C.) to enable the thermoplastic syndiotactic-1,2-polybutadiene to be melted into the rubber composition as it is being mixed. In other words, the rubber composition containing the thermoplastic syndiotactic-1,2-polybutadiene is mixed to a maximum temperature of at least 10° C. higher than the melting point of the thermoplastic-1,2-polybutadiene.

Desirably the aforesaid reinforcing filler is limited to rubber reinforcing carbon black.

Representative of various rubber reinforcing carbon blacks may be found, for example and not intended to be limiting, in The Vanderbilt Rubber Handbook, 13^{th} Edition, (1990) Pages 416 through 418.

Where the reinforcing filler also contains precipitated silica, the coupling agent may be comprised of, for example, a bis(3-triethoxysilylpropyl)polysulfide containing an average of from about 2 to about 4 connecting sulfur atoms in its polysulfidic bridge or an alkoxyorganomercaptosilane. Representative examples of precipitated silica (amorphous synthetic precipitated silica created by acidification of an inorganic base treated silica such as for example sodium silicate) are, for example and not intended to be limiting, precipitated silicas from PPG Industries as Hi-Sil™ 210 and HiSil™ 243, silicas from Solvay such as, for example, Zeosil 1165™MP and silicas from Evonic as, for example, VN2™ and VN3™.

The aforesaid method of this invention further comprises sulfur curing the prepared composite of annular tire bead containing the circumferential apex rubber strip (the pre-apexed bead).

In additional accordance with this invention a pre-apexed tire bead as a composite of an annular tire bead of rubber encapsulated plurality of wire cords with a circumferential apex rubber strip is provided, particularly as prepared by the aforesaid method as well as a sulfur cured composite thereof.

In further accordance with this invention, such method further includes building an uncured tire assembly containing the prepared uncured pre-formed apex/bead composite (pre-apexed bead) with the rubber apex extending radially outward from the tire bead into an associated tire rubber sidewall.

In additional accordance with this invention, such method further includes sulfur curing the tire assembly to form a pneumatic rubber tire (containing the pre-apexed bead).

In additional accordance with this invention, a pneumatic tire is provided as being prepared by such process.

In further accordance with this invention, a pre-apexed annular tire bead (for a pneumatic rubber tire) is provided which comprises an annular tire bead comprised of uncured rubber encapsulated wire cords where said bead contains a uncured rubber apex positioned onto and circumferentially around the outer periphery (the outer surface) of the annular bead,

wherein the radially outer portion of the uncured rubber apex on the annular bead has a stretched length greater than the length of its radially inner portion,

wherein the composition of the rubber apex is comprised of:

(A) at least one diene-based elastomer comprised of at least one of cis 1,4-polyisoprene, polybutadiene and styrene/butadiene rubber (e.g. cis 1,4-polyisoprene rubber and at least one of polybutadiene rubber and styrene/butadiene rubber),

(B) about 1 to about 10, alternately from about 3 to about 7, parts by weight thermoplastic syndiotactic-1,2-polybutadiene per 100 parts by weight of the diene-based elastomer(s), wherein the thermoplastic syndiotactic-1,2-polybutadiene has a melting point (MP) in a range of from about 70° C. to about 130° C. and

(C) about 30 to about 120, alternately about 50 to about 100 phr of reinforcing filler comprised of:
(1) rubber reinforcing carbon black, or
(2) combination of rubber reinforcing carbon black and precipitated silica together with a coupling agent for the precipitated silica having a moiety reactive with hydroxyl groups on the precipitated silica and another different moiety interactive with said diene-based elastomer(s).

In one embodiment, the reinforcing filler for the rubber apex is limited to rubber reinforcing carbon black.

In a further embodiment, the reinforcing filler for the rubber apex is a combination of rubber reinforcing carbon black and precipitated silica together with a coupling agent for the precipitated silica comprised of a bis(3-triethoxysilylpropyl)polysulfide containing an average of from about 2 to about 4 connecting sulfur atoms in its polysulfidic bridge or an alkoxyorganomercaptosilane.

In further accordance with this invention, pre-apexed tire bead is a sulfur cured pre-apexed tire bead.

In additional accordance with this invention a pneumatic tire is provided which contains the pre-apexed tire bead where the apex extends radially outward from the tire bead into an associated tire rubber sidewall (e.g. a tire rubber sidewall extending from a tire bead radially outward to a tire tread).

In further accordance with this invention, a pneumatic tire is provided as a sulfur cured pneumatic rubber tire.

The following drawings are provided to further understand the invention.

### BRIEF DESCRIPTION OF DRAWINGS

FIG. 1 is a cross-sectional view of a pneumatic tire illustrating apex/bead assembly placements.

FIG. 2 is a perspective view of a pneumatic tire illustrating apex/bead assembly placements.

FIG. 3 is a perspective view illustrating a process of extrusion of a rubber apex circumferentially around and onto an annular tire bead.

FIGS. 4A, 4B, 4C and 4D are individual cross sectional views of an apex and tire bead.

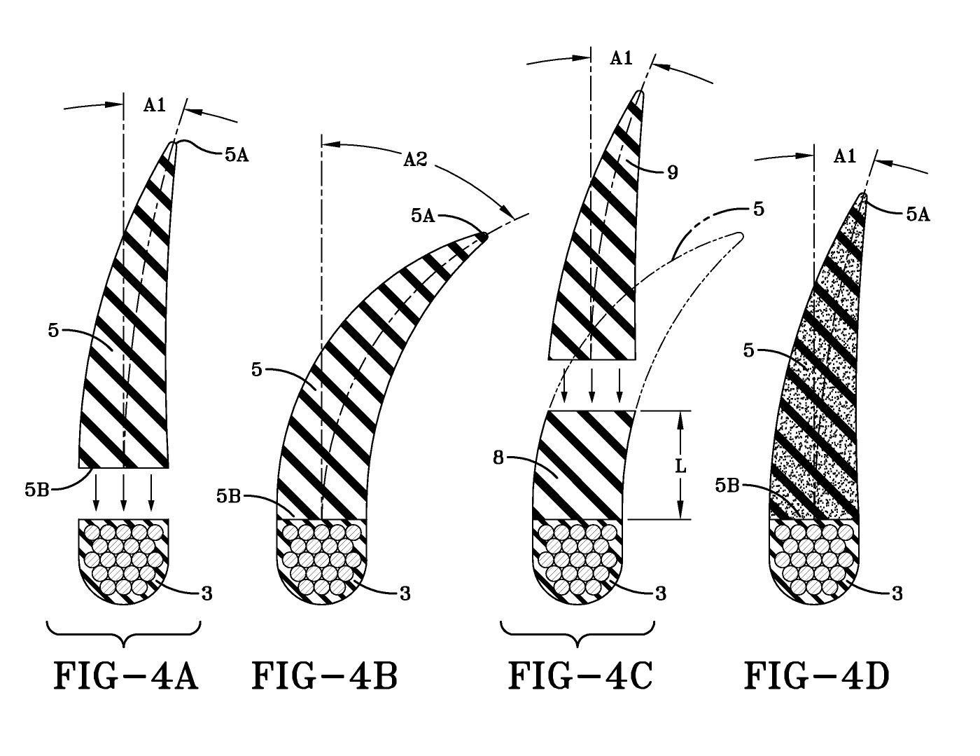

### ADDITIONAL DESCRIPTIONS OF FIGS. 4A, 4B, 4C AND 4D

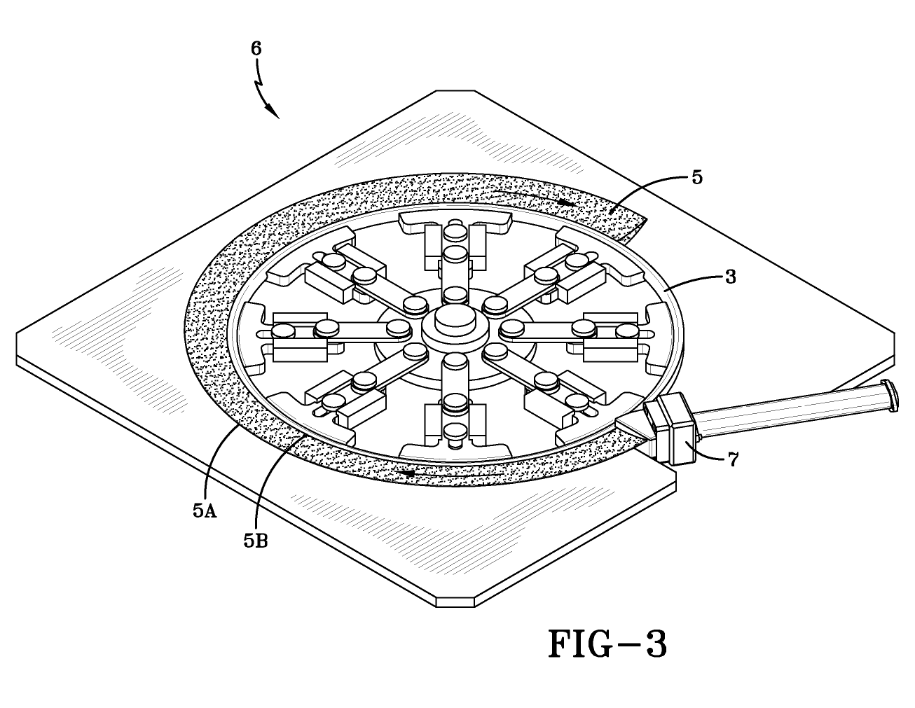

FIG. 4A illustrates a bead of rubber encapsulated metal cords to which a shaped uncured rubber apex is to be combined to form a composite thereof by the process illustrated in FIG. 3.

FIG. 4B illustrates a composite of uncured rubber apex and bead prepared by a process illustrated in FIG. 3 in which the outer portion of the shaped apex is deformed by the process of preparation in which the outer portion of the apex is stretched by the aforesaid process.

FIG. 4C illustrates the composite of FIG. 4B having been truncated by not including the aforesaid outer portion of the apex with the deleted outer portion being phantom outlined.

FIG. 4D illustrates a composite of uncured rubber apex and tire bead (pre-apexed tire bead) prepared by a process illustrated in FIG. 3 in which the outer portion of the applied apex is not deformed by such process in which the rubber composition of the rubber apex contains a syndiotactic-1,2-polybutadiene.

### The Drawings

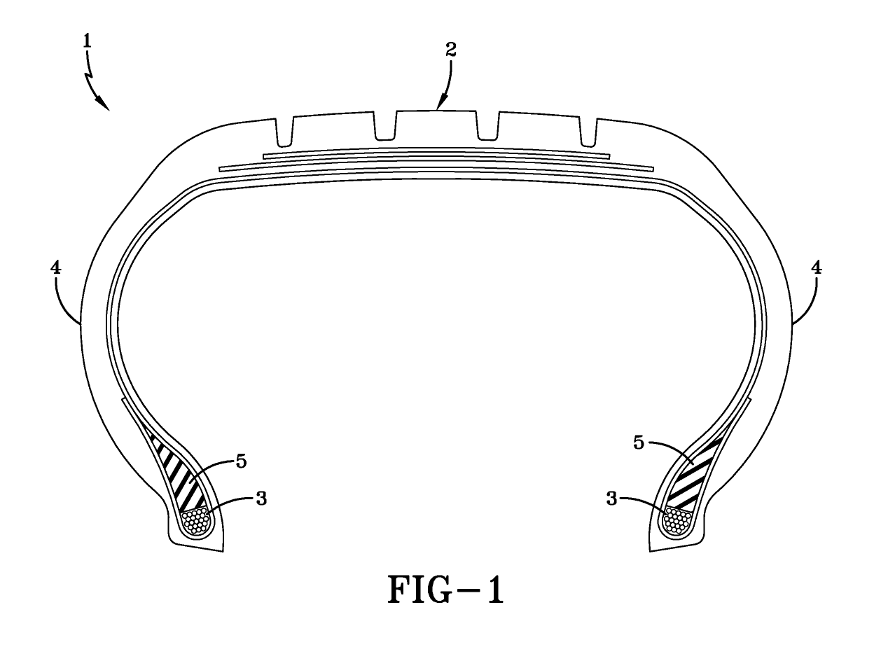

In FIG. 1, a cross sectional view of a pneumatic tire (1) is shown which is composed of a tread (2), tire bead (3) composed of rubber encapsulated metal cords, rubber sidewall (4) extending from the bead portion (3) to the tread (2) of the tire (1) and cured rubber apex (5) extending radially outward from the bead (3) into the sidewall (4) wherein the combination of bead (3) and apex (5) represent an apex/bead assembly.

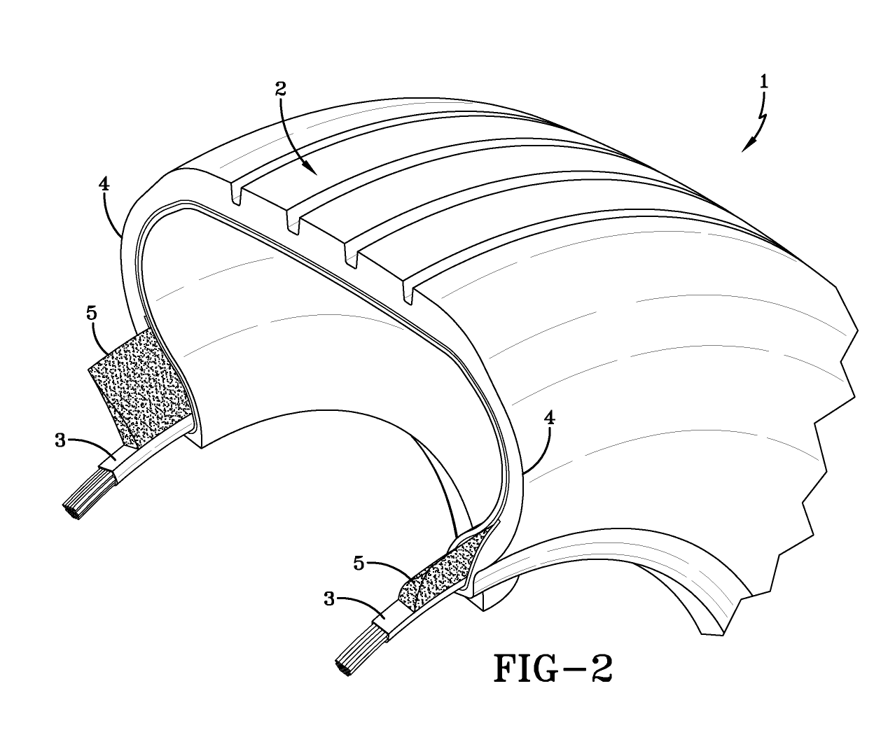

In FIG. 2, a perspective view of a pneumatic tire (1) is shown which is composed of a tread (2), tire bead (3) composed of rubber encapsulated metal cords, rubber sidewall (4) extending from the bead portion (3) to the tread (2) of the tire (1) and cured rubber apex (5) extending radially outward from the bead (3) into the sidewall (4) wherein the combination of bead (3) and apex (5) represent an apex/bead assembly.

In FIG. 3, rotatable wheel (6) is shown to illustrate a process in which an annular tire bead (3) of rubber encapsulated wire cords is fitted to its periphery and to which an extruder (7) is shown as applying an extruded and shaped rubber apex (5) of an uncured rubber composition onto and circumferentially around the fitted bead (3). The applied apex has a radial outer portion (5A) which is thereby stretched beyond its original extruded shape as it is wound around the fitted bead (3) and a radial inner portion (5B), which does not become significantly stretched, if it is stretched at all and at least not to the extent that its radial outer portion is stretched, to form a pre-apexed tire bead.

In FIG. 4A a cross section of an annular bead (3) of rubber encapsulated wire cords is shown to which an extruded rubber apex (5) of an uncured rubber composition composed of diene-based elastomers having its outer portion (5A) being extrusion-shaped to deviate from its inner portion (5B) by an angle of (A1). The rubber apex (5) is to be applied to the annular bead (3) by the process illustrated in FIG. 3.

In FIG. 4B, a cross section of an annular bead (3) of rubber encapsulated wire cords is shown to which an extruded, shaped rubber apex (5) of an uncured rubber composition composed diene-based elastomers, having an outer portion (5A) and inner portion (5B), has been applied onto and circumferentially around the annular bead (3) by a process illustrated in FIG. 3. In FIG. 4B the stretched outer portion (5A) of the apex (5) is shown as being visibly deformed by curling inward in a direction toward its inner portion (5B) caused by the stretched outer apex rubber portion (5A) attempting to return to its original unstretched condition after application by the process illustrated in FIG. 3. The extent of curled angular deformation (A2) of the apex (5) is significantly greater than the original angle (A1) and therefore presents a shape considered to be unsatisfactory for use in building the tire illustrated in FIG. 1 and FIG. 2.

In FIG. 4C, an alternative assembly is illustrated in which a truncated, or shortened, uncured rubber apex (8) composed of a diene-elastomer rubber composition is applied onto and circumferentially around an annular bead (3) by the process illustrated in FIG. 3 for which the amount of curled deformation of the shortened apex (8) caused by its stretching is comparatively minimized because of its shortened height. Then, to complete the apex, an apex extension (9) is later built onto the shortened apex (8) during the tire building process instead by the process illustrated in FIG. 3.

In FIG. 4D, a cross section of an annular bead (3) of rubber encapsulated wire cords is shown to which an extruded, shaped rubber apex (5) of an uncured rubber composition containing diene-based elastomers which also contains a thermoplastic syndiotactic-1,2-polybutadiene polymer is applied by the process illustrated in FIG. 3 to form a pre-apexed tire bead. In FIG. 4D it is seen that the portion (5A) of the applied rubber apex (5) has the same angular inclination (declination) (A1) as in FIG. 4A and therefore does not present a curled deformation and is therefore satisfactory for building the apex/bead composite (pre-apexed tire bead) into a tire assembly to form a tire containing such pre-apexed bead.

In practice, the syndiotactic polybutadiene (SPBD) might be prepared, for example, in an inert organic solvent such as, for example, utilizing a procedure described in U.S. Pat. No. 3,901,868 or in an aqueous medium utilizing a process described in U.S. Pat. No. 4,506,031 and such patents are incorporated herein in their entirely as a reference for such SPBD methods of preparation.

As indicated, the syndiotactic-1,2-polybutadiene purposefully has a melting point in a range from about 70° C. to about 130° C. so that it will adequately melt into the uncured rubber composition as it is being mixed to a temperature, for example, of from about 150° C. to about 170° C. Such mixing is usually carried out in an internal rubber mixer.

In one embodiment, the styrene/butadiene rubber (solution or emulsion polymerization derived) for the rubber composition of the apex may be functionalized by containing functional groups reactive with hydroxyl groups contained on the precipitated silica. Such functional groups may be, for example, at least one of amine, siloxy and thiol groups.

In one embodiment, the functionalized styrene/butadiene rubber may be tin coupled.

Other conventional compounding ingredients may also, of course, be included in the rubber composition including, for example, zinc oxide, zinc stearate, various processing aids as well as sulfur or sulfur containing compounds together with one or more sulfur cure accelerators.

The following Examples are provided to illustrate the invention and are not intended to limit the scope in which it can be practiced. Unless otherwise indicated, parts and percentages are by weight.

### EXAMPLE I

Rubber samples were prepared to evaluate use of various syndiotactic-1,2-polybutadienes in rubber compositions intended for use as tire apex strip. The basic rubber composition (amounts rounded) for this Example is reported in the following Table 1 with parts and percentages, where appropriate, by weight unless otherwise indicated.

TABLE 1

| Compound | Parts (phr) |
|---|---|
| Non-Productive Mixing (NP) | |
| Natural cis 1,4-polyisoprene rubber | 60 |
| Emulsion SBR¹ | 40 or 35 |
| Syndiotactic-1,2-polybutadiene | 0 or 5 |
| (reported in this Table as a rubber)² | |
| Rubber reinforcing carbon black (N326)³ | 87 |
| Zinc oxide | 3 |
| Fatty acid⁴ | 1 |
| Rubber processing oil | 6 |
| Reinforcing resin (product of methylene donor and | 10 |
| acceptor compounds) | |
| Productive Mixing (P) | |
| Sulfur | 4 |
| Sulfur cure accelerator(s)⁵ | 2.8 |
| Sulfur cure retarder⁶ | 0.3 |

¹Styrene/butadiene elastomer prepared by aqueous emulsion polymerization containing about 23.5 percent bound styrene, 50 Mooney viscosity, as PLF1502 ™ from The Goodyear Tire & Rubber Company
²Syndiotactic-1,2-polybutadiene having melting points of 71, 95, 105 and 126° C., respectively. For this Table, it is conveniently being reported as part of the rubber since the polymer eventually cures in the rubber composition to form a rubbery polymer (elastomer).
³Rubber reinforcing carbon black as N326, an ASTM designation
⁴Fatty acid comprised primarily of stearic, palmitic and oleic acids
⁵Sulfur cure accelerator as a sulfenamide
⁶Sulfur cure retarder as N-Cyclohexylthiophthalimide

For this evaluation, rubber Samples A through E were evaluated.

Control rubber Sample A was prepared with its elastomer components being a combination of natural rubber and emulsion SBR rubber without the syndiotactic-1,2-polybutadiene polymer.

Experimental rubber Samples B through E were prepared comprised of their elastomer components being a combination of natural rubber and emulsion SBR together with syndiotactic polybutadiene polymers of varying melting points.

The rubber compositions were prepared by blending the ingredients in an internal rubber mixer in a series of sequential mixing steps while sheeting out the rubber mixtures and cooling to a temperature below 40° C. between mixing steps. The sequential mixing steps were comprised of a non-productive mixing step(s) with a drop temperature of about 160° C. (temperature of removal of the rubber from the internal rubber mixer), (NP), followed by a productive mixing step (P) with a drop temperature of about 110° C., (in which sulfur and sulfur cure accelerators and retarder were added).

Such sequential mixing steps are well known to those having skill in such art.

### Curl Test

A curl test is provided to evaluate a tendency for an outer portion of an uncured rubber strip to curl inwardly as it is bent to an open ended circular (annular) configuration (shape).

For the curl test, a strip of uncured rubber composition is provided as an extrusion of uncured rubber through a Garvey die head. Such strip Garvey extrudate has a cross-sectional, somewhat triangular shaped configuration comprised of a base portion and apex portion, somewhat similar to the shape illustrated in FIG. 4A. The length of the strip of Garvey extrudate can be, for example, about 10 cm.

The strip of Garvey extrudate is bent to form an open ended ring of a circular configuration with its base portion constituting the inner portion of the ring and its apex portion constituting the peripheral outer portion of the ring.

The circular configuration of the strip of Garvey extrudate may be formed manually or be formed by wrapping the strip around a suitable mandrel (e.g. cylindrical or circular shaped mandrel).

The peripheral outer portion of the formed ring of the strip of Garvey extrudate is thereby stretched beyond the length of its original extruded form and beyond the length of its radially inner portion.

A visual observation is made of the stretched outer peripheral portion of the rubber strip of Garvey extrudate in its circular form to evaluate its tendency to curl inward toward the radially inner portion of the circular configured strip. A rating of from 1 to 10 is provided for the degree of observed curl of the outer peripheral portion toward its radially inner portion. A rating of 10 is provided for an observed no curl deformation of the strip and a rating of 1 is provided for an observed severe curl deformation of the strip.

The following Table 2 reports cure behavior and various physical properties of rubber Samples A through E based upon the formulation of Table 1 as well as a curl rating for the uncured, extruded, rubber Samples A through E. The rubber samples were sulfur cured, where appropriate, for about 11 minutes at about 170° C.

TABLE 2

| | | Parts (phr) | | | |
|---|---|---|---|---|---|
| | Control | Exp'l Rubber Samples | | | |
| | A | B | C | D | E |
| Elastomers | | | | | |
| Natural cis 1,4-polyisoprene rubber | 60 | 60 | 60 | 60 | 60 |
| Emulsion SBR | 40 | 35 | 35 | 35 | 35 |
| SPBD polymer, | NA | 71 | 95 | 105 | 126 |
| (melting point, ° C.) | | | | | |
| Properties | | | | | |
| Stress Strain | | | | | |
| (11 minutes at 170° C.)¹ | | | | | |
| Tensile strength (MPa) | 14.3 | 13.2 | 12.8 | 13.5 | 13.3 |
| Elongation at break (%) | 159 | 143 | 132 | 143 | 142 |
| Modulus 100% (MPa) | 10.2 | 10.4 | 10.6 | 10.6 | 10.6 |
| Rebound, Zwick (%) 100° C. | 45 | 44 | 47 | 44 | 45 |
| RPA, 100° C., 1 Hertz⁶ | | | | | |
| Storage modulus (G′), | 25.6 | 25.1 | 21.8 | 24.6 | 27 |
| 1% strain (MPa) | | | | | |
| Storage modulus (G′), | 8.4 | 7.2 | 7.2 | 7 | 7.5 |
| 10% strain (MPa) | | | | | |
| Apex curling laboratory test | 4 | 9 | 9 | 8 | 8 |
| (Rating on a scale of from 1 to 10) | | | | | |

¹Data by Instron Testing System instrument of the Instron Corporation
²Rubber Processing Analysis test

From Table 2 it is observed that the replacement of 5 phr of the emulsion SBR with 5 phr of various melting point SPBDs had only a small effect on the cured properties shown in this table.

An important feature of the SPBD addition for this Example is the observed resistance of the rubber sample of the uncured rubber apex composition to curl when submitted to the curl test. This is considered to be predictive of resistance of an uncured rubber apex composite to curl upon being applied onto and circumferentially about an annular tire bead to create an apex/bead composite in a form of a pre-apexed bead.

In this example, a curl value of 9 was observed for rubber Samples B and C which contained 5 parts by weight per 100 parts by weight rubber of syndiotactic-1,2-polybutadienes having melting points of 71° C. and 95° C., respectively which represents an observed acceptable very little curl as compared to an unacceptable excessive curl value of 4 for the rubber composition of control rubber Sample A without the syndiotactic polybutadiene addition.

In this example, a curl value of 8 was observed for rubber Samples D and E which contained 5 parts by weight per 100 parts by weight rubber of syndiotactic-1,2-polybutadienes having melting points of 105° C. and 126° C., respectively which represents an observed usually acceptable very little curl as compared to an unacceptable excessive curl value of 4 for the rubber composition of Control rubber Sample A without the syndiotactic polybutadiene addition.

Control rubber Sample A which did not contain syndiotactic polybutadiene with a laboratory curl test value of 4. Such rubber sample would not be recommended for use as a pre-apexed annular tire bead created by extruding an uncured rubber apex onto and circumferentially around an annular tire bead. In general, it is considered that such apex rubber composition presenting a curl value of less than 7 would considered as being unsatisfactory for such pre-apexed bead preparation process.

Accordingly, it is observed that the rubber compositions of rubber Samples B through E presented sufficiently minimal curl data which is predictive of acceptable performance in a tire building process that first produces a pre-apexed tire bead comprised of extruding an uncured rubber apex onto and circumferentially around an annular tire bead in a tire building process.

### EXAMPLE II

With the positive curl results obtained in Example I, samples of rubber compositions were prepared to evaluate use of various levels of a syndiotactic-1,2-polybutadiene having a melting point of about 71° C. in rubber compositions as being indicative of a tire apex strip.

The basic rubber composition (amounts rounded) for this Example is reported in the following Table 3 with parts and percentages, where appropriate, by weight unless otherwise indicated.

TABLE 3

| Compound | Parts (phr) |
|---|---|
| Non-Productive Mixing (NP) | |
| Natural cis 1,4-polyisoprene rubber | 60 |
| Emulsion SBR¹ | 40 or 33 |
| Syndiotactic-1,2-polybutadiene rubber | 3 to 7 |
| (reported as part of the rubber)² | |
| Rubber reinforcing carbon black (N326)³ | 87 |
| Zinc Oxide | 3 |
| Fatty acid⁴ | 1 |
| Rubber processing oil | 6 |
| Reinforcing resin (product of methylene donor and | 10 |
| acceptor compounds) | |
| Productive Mixing (P) | |
| Sulfur | 4 |
| Sulfur cure accelerator(s)⁵ | 2.8 |
| Sulfur cure retarder⁶ | 0.3 |

¹Styrene/butadiene elastomer prepared by aqueous emulsion polymerization containing about 23.5 percent bound styrene, 50 Mooney viscosity, as PLF1502 ™ from The Goodyear Tire & Rubber Company
²Syndiotactic-1,2-polybutadiene having melting point of 71° C., conveniently reported in the Table as part of the rubber since the polymer cures in the rubber formulation to form a rubbery polymer (elastomer)
³Rubber reinforcing carbon black as N326, an ASTM designation
⁴Fatty acid comprised primarily of stearic, palmitic and oleic acids
⁵Sulfur cure accelerator as a sulfenamide
⁶Sulfur cure retarder as N-Cyclohexylthiophthalimide

For this evaluation, rubber Samples F through I were evaluated.

Control rubber Sample F was prepared with its elastomer components being a combination of natural rubber and emulsion SBR rubber without the syndiotactic-1,2-polybutadiene polymer.

Experimental rubber Samples G through I were prepared comprised of their elastomer components being a combination of natural rubber and emulsion SBR together with various levels of syndiotactic polybutadiene polymer having a melting point of 71° C.

The rubber compositions were prepared by blending the ingredients in an internal rubber mixer in a series of sequential mixing steps while sheeting out the rubber mixtures and cooling to a temperature below 40° C. between mixing steps. The sequential mixing steps were comprised of a non-productive mixing step(s) with a drop temperature of about 160° C. (temperature of removal of the rubber from the internal rubber mixer), (NP), followed by a productive mixing step (P) with a drop temperature of about 110° C., (in which sulfur and sulfur cure accelerators and retarder were added).

Such sequential mixing steps are well known to those having skill in such art.

The following Table 4 reports cure behavior and various physical properties of rubber Samples F through I based upon the formulation of Table 1 as well as a curl rating for the uncured, extruded, rubber Samples F through I. The rubber samples were sulfur cured, where appropriate, for about 11 minutes at about 170° C.

TABLE 4

| | | Parts (phr) | | |
|---|---|---|---|---|
| | | Exp'l Rubber | | |
| | Control | Samples | | |
| | F | G | H | I |
| Elastomers | | | | |
| Natural cis 1,4-polyisoprene rubber | 60 | 60 | 60 | 60 |
| Emulsion SBR | 40 | 37 | 35 | 33 |
| SPBD polymer, parts by weight | NA | 3 | 5 | 7 |
| (MP = 71° C.) | | | | |
| Properties | | | | |
| Stress Strain (11 minutes at 170° C.)¹ | | | | |
| Tensile strength (MPa) | 14.9 | 14.9 | 15.4 | 15.3 |
| Elongation at break (%) | 165 | 161 | 174 | 163 |
| Modulus 100% (MPa) | 10.2 | 10.5 | 10.4 | 10.4 |
| Rebound, Zwick (%) 100° C. | 46 | 45 | 46 | 46 |
| RPA, 100° C., 1 Hertz⁶ | | | | |
| Storage modulus (G′), 1% strain (MPa) | 25.3 | 26.2 | 25.3 | 21 |
| Storage modulus (G′), 10% strain (MPa) | 7.3 | 6.8 | 7 | 6.7 |
| Apex curling laboratory test | 4 | 9 | 8 | 10 |
| (Rating from 1 to 10) | | | | |

¹Data by Instron Testing System instrument of the Instron Corporation
²Rubber Processing Analysis test

From Table 4 it is observed that the replacement of 3 to 7 parts by weight of the emulsion SBR with the SPBD having a melting point of about 71° C. had minimal effect of on the cured properties shown in this table.

An important feature of the SPBD addition for this Example is the observed resistance of uncured rubber apex composition to curl when submitted to the curl test. This is considered to be predictive of resistance of an uncured rubber apex composite to curl upon being applied onto and circumferentially about an annular tire bead to create an apex/bead composite in a form of a pre-apexed bead.

In this example, curl values of 8 to 10 were observed for rubber Samples G, H and I which contained 3, 5 and 7 parts, respectively of the SPBD for which an observed acceptable very little, if any, curl was observed. An unacceptable excessive curl value of 4 was observed for the rubber composition of Control rubber Sample F without the syndiotactic polybutadiene addition.

In this example, a curl value of 10 by this test was observed for rubber Sample I which contained 7 parts by weight per 100 parts by weight rubber of syndiotactic-1,2-polybutadiene having a melting point of 71° C. This value of 10 represents no observed curling of the uncured rubber Sample. This result indicates an acceptable upper level of the SPBD for obtaining an acceptable little or no curl by this test, particularly where the SPBD has a melting point below the mixing temperature reached for the uncured rubber composition to enable the SPBD to melt into the rubber composition as it is being mixed and particularly predictive for preparation of a pre-apexed tire bead and a tire containing such pre-apexed bead.

While certain representative embodiments and details have been shown for the purpose of illustrating the invention, it will be apparent to those skilled in this art that various changes and modifications may be made therein without departing from the spirit or scope of the invention.

What is claimed is:

1. A method of preparing a tire apex/bead composite comprises mixing a sulfur curable rubber composition in which a maximum mixing temperature in a range of from about 140 to about 180° C. is reached and extruding the uncured sulfur curable rubber composition through a suitable die to form and apply an uncured apex rubber strip onto and circumferentially around the outer periphery of an annular bead comprised of uncured sulfur curable rubber encapsulated plurality of wire cords,
whereby the outer peripheral portion of the uncured rubber apex strip is caused by such method to be stretched beyond its original extruded length and beyond the length of the radially inner portion of the uncured rubber apex adjacent to the annular tire bead,
wherein the composition of the rubber apex is comprised of:
(A) at least one diene-based elastomer comprised of at least one of cis 1,4-polyisoprene, polybutadiene and styrene/butadiene rubber,
(B) about 1 to about 10 parts by weight syndiotactic-1,2-polybutadiene per 100 part by weight of the elastomer(s), wherein the syndiotactic-1,2-polybutadiene has a melting point (MP) in a range of from about 70° C. to about 130° C. and
(C) about 30 to about 120 phr of reinforcing filler comprised of:
(1) rubber reinforcing carbon black, or
(2) combination of rubber reinforcing carbon black and precipitated silica together with a coupling agent for the precipitated silica having a moiety reactive with hydroxyl groups on the precipitated silica and another different moiety interactive with said diene-based elastomer(s).

2. The method of claim 1 wherein the reinforcing filler is rubber reinforcing carbon black.

3. The method of claim 1 wherein the reinforcing filler is a combination of rubber reinforcing carbon black and precipitated silica together with a coupling agent for the precipitated silica comprised of a bis(3-triethoxysilylpropyl)polysulfide containing an average of from about 2 to about 4 connecting sulfur atoms in its polysulfidic bridge or an alkoxyorganomercaptosilane.

4. The method of claim 1 wherein the diene-based elastomers are comprised of cis 1,4-polyisoprene and at least one of styrene/butadiene rubber and polybutadiene rubber.

5. The method of claim 1 wherein the apex rubber composition contains from 3 to 7 parts by weight of the syndiotactic-1,2-polybutadiene per 100 parts by weight of diene-based elastomers and where the radially outer portion of the uncured rubber apex is stretched beyond the length of its radially inner portion.

6. The method of claim 1 wherein the melting point of the syndiotactic-1,2-polybutadiene is at least 10° C. less than the maximum mixing temperature reached for preparation of the apex rubber composition.

7. The method of claim 1 which further comprises sulfur curing the prepared composite of annular bead containing the circumferential apex rubber strip.

8. The method of claim 1 wherein said annular tire bead is comprised of a rubber encapsulated plurality of wire cords.

9. An apex/bead composite prepared by the method of claim 1.

10. An apex/bead composite prepared by the method of claim 7.

11. The method of claim 1 which further comprises building an uncured tire assembly containing the prepared uncured pre-formed apex/bead composite, with the rubber apex extending radially outward from the tire bead into an associated tire sidewall.

12. The method of claim 11 which further includes sulfur curing the tire assembly to form a pneumatic rubber tire.

13. A pneumatic tire prepared by the method of claim 12.

14. A pre-apexed annular tire bead which comprises an annular tire bead comprised of uncured rubber encapsulated wire cords where said bead contains a uncured rubber apex positioned circumferentially around and onto the outer periphery of the annular bead,
wherein the radially outer portion of the uncured rubber apex on the annular bead has a length stretched beyond the length of its radially inner portion,
wherein the composition of the rubber apex is comprised of:
(A) at least one diene-based elastomer comprised of at least one of cis 1,4-polyisoprene, polybutadiene and styrene/butadiene rubber,
(B) about 1 to about 10 parts by weight syndiotactic-1,2-polybutadiene per 100 part by weight of the elastomer(s), wherein the syndiotactic-1,2-polybutadiene has a melting point (MP) in a range of from about 70° C. to about 130° C. and
(C) about 30 to about 120 phr of reinforcing filler comprised of:
(1) rubber reinforcing carbon black, or
(2) combination of rubber reinforcing carbon black and precipitated silica together with a coupling agent for the precipitated silica having a moiety reactive with hydroxyl groups on the precipitated silica and another different moiety interactive with said diene-based elastomer(s).

15. The pre-apexed tire bead of claim 14 wherein the reinforcing filler is rubber reinforcing carbon black.

16. The pre-apexed tire bead of claim 14 wherein the reinforcing filler is a combination of rubber reinforcing carbon black and precipitated silica together with a coupling gent for the precipitated silica comprised of a bis(3-triethoxysilylpropyl)polysulfide containing an average of from about 2 to about 4 connecting sulfur atoms in its polysulfidic bridge or an alkoxyorganomercaptosilane.

17. The pre-apexed tire bead of claim 14 which is a sulfur cured pre-apexed tire bead.

18. The pre-apexed tire bead of claim 14 wherein the annular tire bead is comprised of a rubber encapsulated plurality of wire cords.

19. A pneumatic rubber tire which contains the pre-apexed tire bead of claim 14 where the apex extends radially outward from the tire bead into an associated tire sidewall.

20. The pneumatic tire of claim 19 comprised of a sulfur cured pneumatic rubber tire.
